(19) United States
(12) Patent Application Publication
(10) Pub. No.: US 2015/0012365 A1
(43) Pub. Date: Jan. 8, 2015

(54) CONCIERGE-SHOPPING WIDGET-METHOD FOR USER MANAGED PROFILE AND SELECTIVE TRANSMISSION THEREOF

(71) Applicant: Intellectual Ventures Fund 83 LLC, Las Vegas, NV (US)

(72) Inventors: Dale F. McIntyre, Honeoye Falls, NY (US); Kevin M. Gobeyn, Rochester, NY (US)

(21) Appl. No.: 14/492,295

(22) Filed: Sep. 22, 2014

Related U.S. Application Data
(63) Continuation of application No. 12/195,754, filed on Aug. 21, 2008.

(51) Int. Cl. G06Q 30/02; G06F 21/60; G06F 17/30

(52) U.S. Cl. CPC G06Q 30/0269; G06F 17/30702; G06F 21/60
USPC 705/14.66

(57) ABSTRACT

A method for managing user-interest information implemented by a data processing device. A set of user-provided conditions are accessed, which are based either on content of released information, on limitations on use of released information, or on both. The user-interest information or a derivative thereof is transmitted to a recipient, subject to the user-provided conditions.

### CROSS-REFERENCE TO RELATED PATENT APPLICATIONS

This application is a Continuation of U.S. application Ser. No. 12/195,754, filed Aug. 21, 2008, incorporated herein by reference in its entirety.

### FIELD

This disclosure generally relates to transmission of personal data between networked processors and more particularly relates to methods for controlling the content and use of the information provided.

### BACKGROUND

On-line marketing enables retailers to promote their products to a broad customer base at a favorable cost and allows consumers the ability to search for and view items of interest at their own convenience, without the trouble and expense typically required for traveling to a retail outlet. Of particular value to retailers and advertisers in general, as well as to anyone soliciting funds or support, is the ability to target their message to a user according to information obtained about the user. By knowing something about the receiver of a message, request, or offer, the sender can more carefully craft the presentation of a product or service, highlighting items or features that are more likely to be of interest to a particular user. This also reduces the risk of presenting material that is of no interest to the user and that may frustrate and even prompt the viewer to block reception from a site or to look elsewhere for a product or service.

Information about the user, which can be generated and stored as a user profile, is thus of particular value to the on-line advertiser, retailer, service provider, or other organization. Data such as age, sex, address, professional status, family composition, financial or credit data, police record, waist and inseam size, blood type, hair style, hobbies, pets, favorite vacation haunts, and other such personal information can be included in a user profile, for example. User profile information can be generated from any of a number of sources. Internet behavior patterns can provide various types of information suitable for a user profile. For example, sites visited, search strings entered, purchases made, and other data from on-line activity can help to provide user profile information that is useful for devising an appropriate approach to presentation of material. Information gleaned from a collection of digital records maintained for the user, such as from digital images, from audio files, from text files, and from other types of records identified with a user account can also be particularly helpful in generating a user profile. In some cases, users themselves may voluntarily provide some amount of personal information that they are willing to share with trusted entities.

Privacy risks remain a concern. A user may be willing to share certain personal information with a particular retailer or with another on-line provider of goods and services, for example, but unwilling to let this information be made available to unknown third parties. There can also be ethical concerns on the retailer end, where transaction information could be tracked and unwittingly or surreptitiously obtained without regard to user privacy. It may not be prudent or permissible to save certain personal information about a particular user or to share this information with subsidiaries, partners, or other parties. On the other hand, it may be helpful, preferable, or simply generally acceptable to save certain user profile information for a limited span of time.

It can be appreciated that, while there can be significant advantages to on-line marketing solutions that serve users more effectively by taking advantage of user profile information, these solutions may encounter some resistance if customers feel threatened by a loss of privacy. Thus, there is a need for solutions that achieve a favorable tradeoff between privacy and convenience for on-line advertisers, retailers, non-profit organizations, and their potential customers and supporters.

### SUMMARY

The method of the present disclosure, implemented at least in part by a computer or other suitable type of data processing device for managing user-interest information, accesses a set of user-provided conditions that define either or both the content of information released and limitations on how the released user information is used. The method transmits at least some of the user interest information or information that can be derived from the user-interest information, to a recipient, subject to the set of user-provided conditions.

According to some embodiments, the present disclosure provides a method implemented at least in part by a data processing device for managing user-interest information, the method involving the steps of accessing a set of user-provided conditions including either (a) content of released information from the user-interest information, (b) limitations on use of released information from the user-interest information, or both (a) and (b); and transmitting at least some of the user-interest information or a derivative thereof to a recipient subject to the set of user-provided conditions.

Advantageously, the present disclosure allows a measure of user control over what information is made available to a recipient and over how this information can be used.

In addition to the embodiments described above, further embodiments will become apparent by reference to the drawings and by study of the following detailed description.

### BRIEF DESCRIPTION OF THE DRAWINGS

The present disclosure will be more readily understood from the detailed description of exemplary embodiments presented below considered in conjunction with the attached drawings, of which:

FIG. 1 schematically illustrates a system for identifying user subject interests according to an embodiment of the present disclosure;

FIG. 2 depicts a schematic block diagram showing the overall context of an embodiment of the present disclosure;

FIG. 3 depicts a schematic diagram showing user-controlled portions of the data flow for generating user-provided conditions according to an embodiment of the present disclosure;

FIG. 4 depicts a schematic diagram showing an example of user selected granularity levels that can control the level of content specificity provided by a manager according to an embodiment of the present disclosure;

FIG. 5 depicts a single session use for user-interest information according to an embodiment of the present disclosure;

FIG. 6 depicts a communication timing diagram according to an embodiment of the present disclosure;

FIGS. 7A and 7B depict block diagrams for an illustrative example of embodiments of the present disclosure.

It is to be understood that the attached drawings are for purposes of illustrating the concepts of the disclosure and may not be to scale.

### DETAILED DESCRIPTION OF THE PREFERRED EMBODIMENTS

Embodiments of the present disclosure control the distribution and use of user interest information according to user-provided conditions that define either or both the content of information released and limitations on how the released user information is used. Embodiments of the present disclosure transmit at least some of the user interest information or information that can be derived from the user-interest information, to a recipient, subject to the set of user-provided conditions.

The phrase “digital media record,” as used herein, includes digital still images as well as digital video images and digital audio content. Unless otherwise stated, the phrase “digital image,” as used herein, includes digital still images as well as digital video. Also, it should be noted that, unless otherwise explicitly noted or required by context, the word “or” is used in this disclosure in a non-exclusive sense. In addition, functions described herein may be implemented as “software” or “software programs”. Those skilled in the art will recognize, however, that the equivalent functions of such software can also be readily executed in hardware.

### System Hardware

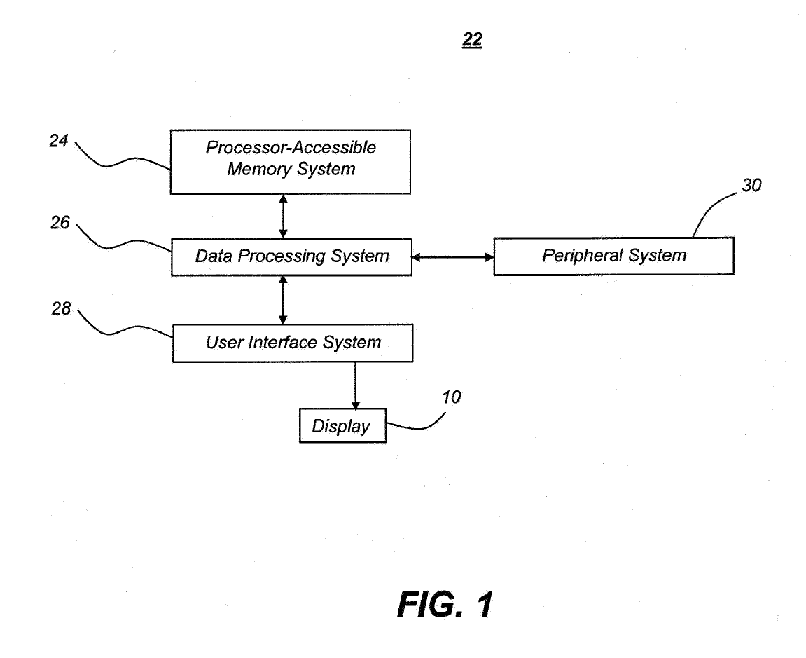

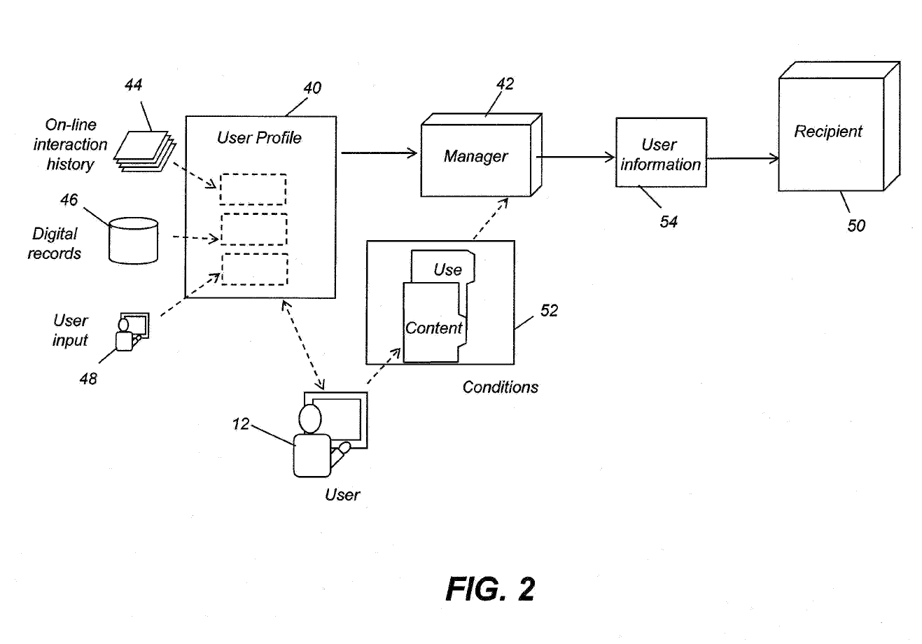

FIG. 1 illustrates a system 22 for managing user-interest information according to an embodiment of the present disclosure. The system 22 includes a data processing system 26, a peripheral system 30, a user interface system 28, and a processor-accessible memory system 24. The processor-accessible memory system 24, the peripheral system 30, and the user interface system 28 are communicatively connected to the data processing system 26. The data processing system 26 includes one or more data processing devices that implement the processes of the various embodiments of the present disclosure, including the example processes of FIG. 2 described herein.

The phrases “data processing device” or “data processor,” as used herein, includes any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 24 includes one or more processor-accessible memories configured to store information, including the information needed to execute the processes of the various embodiments of the present disclosure, including the example processes of FIG. 2 described herein. The processor-accessible memory system 24 may be a distributed processor-accessible memory system including multiple processor-accessible memories communicatively connected to the data processing system 26 via a plurality of computers and/or devices. On the other hand, the processor-accessible memory system 24 need not be a distributed processor-accessible memory system and, consequently, may include one or more processor-accessible memories located within a single data processor or device.

The phrase “processor-accessible memory,” as used herein, includes any processor-accessible data storage device, whether volatile or nonvolatile, electronic, magnetic, optical, or otherwise, including but not limited to, floppy disks, hard disks, Compact Discs, DVDs, flash memories, ROMs, and RAMs.

The phrase “communicatively connected,” as used herein, includes any type of connection, whether wired or wireless, between devices, data processors, or programs in which data may be communicated. Further, the phrase “communicatively connected,” as used herein, includes a connection between devices or programs within a single data processor, a connection between devices or programs located in different data processors, and a connection between devices not located in data processors at all. In this regard, although the processor-accessible memory system 24 is shown separately from the data processing system 26, one skilled in the art will appreciate that the processor-accessible memory system 24 may be stored completely or partially within the data processing system 26. Further in this regard, although the peripheral system 30 and the user interface system 28 are shown separately from the data processing system 26, one skilled in the art will appreciate that one or both of such systems may be stored completely or partially within the data processing system 26.

The peripheral system 30 may include one or more devices configured to provide digital image records to the data processing system 26. For example, the peripheral system 30 may include digital video cameras, cellular phones, regular digital cameras, or other computers. The data processing system 26, upon receipt of digital image records from a device in the peripheral system 30, may store such digital image records in the processor-accessible memory system 24.

The user interface system 28 may include a mouse, a keyboard, another computer, or any device or combination of devices from which data is input to the data processing system 26. In this regard, although the peripheral system 30 is shown separately from the user interface system 28, the peripheral system 30 may be included as part of the user interface system 28.

The user interface system 28 also includes a display device 10 and a processor-accessible memory, or any device or combination of devices to which data is output by the data processing system 26. In this regard, if the user interface system 28 includes a processor-accessible memory, such memory may be part of the processor-accessible memory system 24 even though the user interface system 28 and the processor-accessible memory system 24 are shown separately in FIG. 1.

The schematic block diagram of FIG. 2 shows some relationships of interest for an understanding of the overall context of the present disclosure. A base of information about a user 12, including information about user interests, is available as data in some type of user profile 40. There are a number of ways by which this information can be obtained and stored. In one embodiment, for example, user profile 40 is maintained and stored as a database data structure and includes a history of user on-line activity as transaction history 44. This can include, for example, information on internet searches, web sites frequently or regularly visited, products purchased and related online transaction information, and similar data.

User profile 40 may also or alternately include information obtained from digital records 46 that are stored in a user account, such as digital images, audio, and other stored content that is associated with the user. There is much that can be learned or inferred about an individual based on that person's collection of images, including hobbies, interests, travel and vacation spots, pets, family, friends, and other interests, for example. Image records, also termed image assets, stored in a digital image-record collection in the processor-accessible memory system 24 (FIG. 1) may also be linked to a variable amount of metadata. This image metadata can include various semantic and structural information related to the conditions under which the image was captured as well as information obtained about image contents. By way of illustration, metadata for a digital image record can include date and time of image capture, the capture location (provided by a Global Positioning Satellite, GPS, for example), camera owner, camera type, image resolution, comments from the operator or viewer of the image, and various data obtained from the image content itself, including information identifying the subject(s) of the image, for example. Semantic information obtained and stored as one type of supplementary metadata for a digital image record can include various information obtained from objects in the image, including data from image analysis tools known in the art, such as various software applications providing object recognition or face detection or recognition.

In other embodiments, user profile 40 contains user input 46 information that is entered directly by the user. In yet another embodiment, user profile 40 is generated or updated dynamically, based on information from the current session of web-based interactions or from queries automatically generated for forming user profile 40 on an as-needed basis. However user profile 40 is formed and maintained, it contains some amount of personal information about the user, including some level of information about user interests and preferences.

### Conditions Defining Content

Still referring to FIG. 2, a manager 42 is capable of accessing the personal information in user profile 40 and of providing some portion or derivative of this as user information 54 to a recipient 50. Embodiments of the present disclosure allow user 12 to set up a set of conditions 52 that dictate what types of user information are available. User-provided conditions 52 thus determine what subset of available information can be provided to recipient 50 as part of user information 54 and how this information can be used.

The basic structures in FIG. 2 give a broad sketch of the context and environment for embodiments of the present disclosure and some of the structures and components that are used. In practice, there can be numerous variations on each of the structures and functional units shown. For example, the function that is provided by manager 42 may be provided by any of a number of logic processing apparatus, such as a personal computer or networked computer or application. As noted earlier, the base of information labeled herein as user profile 40 can be stored or dynamically generated. Recipient 50 can be any type of third party, including a retailer, advertiser, or an organization soliciting funds or support, for example. Conditions 52 may be set up by or for user 12 in various ways, as described in more detail subsequently. These conditions can be managed in any of a number of ways by manager 42. The conditions themselves may be provided directly to recipient 50 so that appropriate action is taken on user information that is obtained. In alternate embodiments, conditions 52 are used indirectly, controlling the behavior of manager 42 with respect to information provided from user profile 40. In this alternate mode, conditions 52 are used by manager 42 to determine how information from user profile 40 is filtered in order to provide an acceptable level of data to recipient 50.

In whatever way manager 42 utilizes user conditions 52, the overall flow of user information 54 to the recipient 50 is controlled in some way based on user conditions, as indicated in FIG. 2. Unlike user profile 40, which may or may not have its content under direct control of the user, user conditions 52 are, at least in some way, under the control of the user.

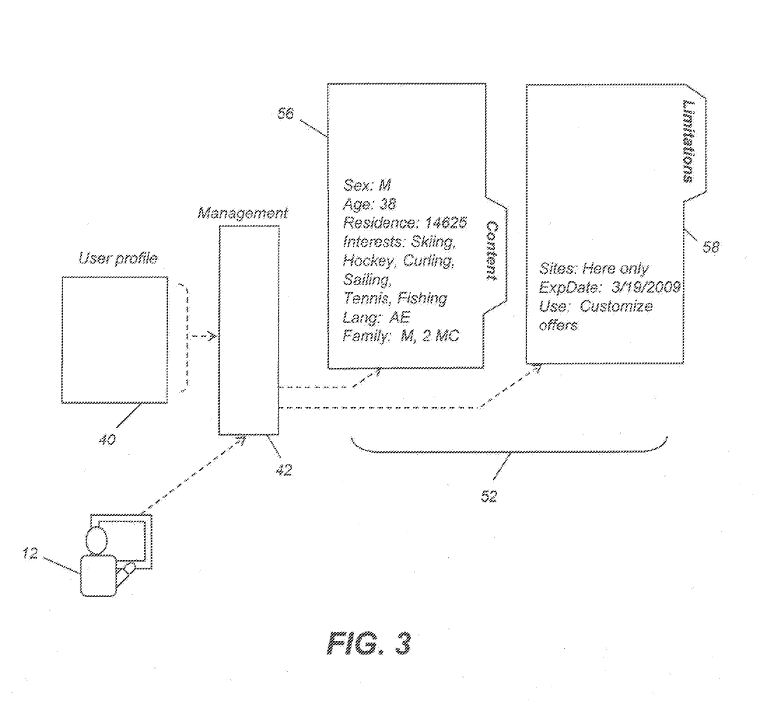

Elaborating upon the basic scheme outlined with respect to FIG. 2, the schematic diagram of FIG. 3 shows user-controlled portions of the data flow for generating user-provided conditions 52 in greater detail. User interaction with the manager 42 application specifies user provided conditions that define content 56 and limitations 58. FIG. 3 gives a few examples of some types of user information that may be relevant for content 56, such as demographic data on sex and age, address or, more broadly, geographical home location, interests, family make-up, language or presentation preferences and other data. These fields are just exemplary, many other types of user information could be provided.

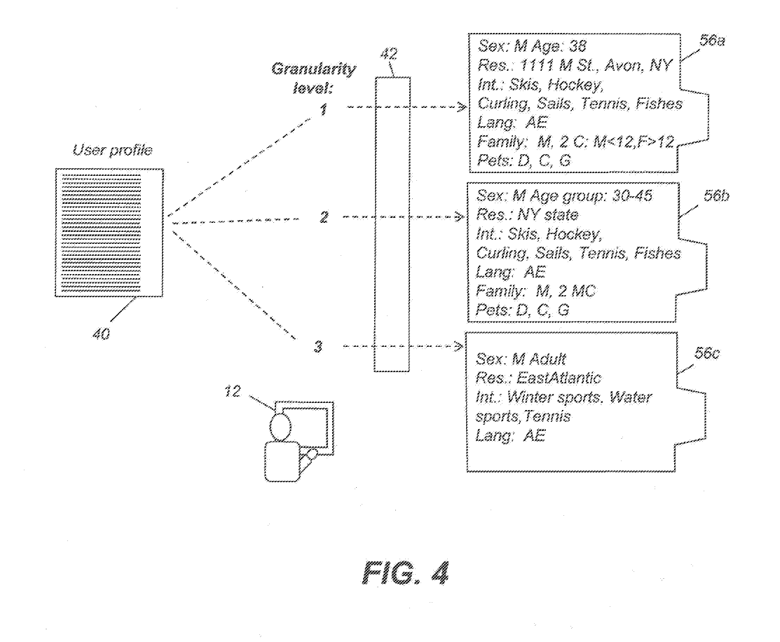

As can be appreciated from FIG. 3, embodiments of the present disclosure can provide a significant measure of user control over what information is provided as content 56. One aspect of this control relates to the relative level of specificity or “granularity” of the information that is made available. Referring to the schematic diagram of FIG. 4, various pre-determined granularity levels can be selected by user 12 to control the level of content specificity as provided by manager 42. In this example, granularity level 1 provides the most specific information from user profile 40 as content 56a. Here, personal information such as age, address, interests, and various family data are extracted from user profile 40 at a first granularity level. Granularity level 2 provides some of the same profile information in content 56b, but with less specific data. For example, an overall age group is listed, rather than the more specific age data given in content 56a. Home residence information gives only the state of residence. Family data lists number of minor children, but does not give any age group indication. Granularity level 3 is even more restrictive with what is provided in content 56c. Here, information merely indicates an adult in the Eastern-Atlantic portion of the US. Even the interests are grouped more generally, to show some level of interest in winter sports and water sports. No family data is made available.

A broad granularity setting, such as that applied for the examples of FIG. 4, is just one way for user control over how much personal data is provided. It can be appreciated that granularity settings with broader scope, such as those described with reference to FIG. 4 are but one example of a type of user-specified granularity that can be implemented. In another embodiment, different granularity settings are provided for different types of user information. For example, user identity and personal data such as name, street address, age, sex, profession, or other data may be subject to one granularity setting. Hat size, waist and inseam measurements, weight, height, and hair color may be subject to another granularity setting. Family information, such as name and age of spouse, names and ages of children, number and type of pets, or other household data may be subject to another separate granularity setting. This arrangement gives the user considerable flexibility for determining how much information of any type is accessible to a recipient.

Whether broad or narrower in scope, granularity settings are only one of a number of possible ways to organize and manage how much personal information about a user is provided. Optionally, some form of template could be used; selection of a standard template by the user then dictates what specific or general personal information is accessible. In yet other embodiments, user 12 specifies, field-by-field, what information fields can be provided from user profile 40. Various approaches can also be used in combination for specifying what information is available. In one embodiment, for example, a pre-defined granularity setting is made for controlling personal identification data, but other data is explicitly approved for access by the user.

Manager 42 can also provide information content that is derived and/or inferred from user profile 40. A few examples of possible derived information are the following:
(i) Age or age group inferred from clothing size and/or style preferences;
(ii) Whether male or female inferred from first name; and
(iii) Favorite professional sports team inferred from zip code.
   Of course, as these examples suggest, inferred and derived information can be inaccurate due to its probabilistic nature, but a relatively high degree of probability may be sufficient in a particular application.

Other factors may also be used to determine the amount of information or detail level of information that is provided as part of the user-provided conditions. One factor that is determinative in one embodiment relates to the type of recipient to whom user interest information is provided. For example, the user may specify some constraints on information that is provided to a specific retailer or advertiser or to different types of networked entities. Thus, for example, a different subset of information may be provided depending on whether the recipient is a retailer or other commercial entity or a non-profit organization. In other embodiments, only specific information may be provided to various types of recipients. A user may have a preferred web site or sites for on-line purchases and may configure to provide a considerable amount of personal information to these sites, such as in return for various special offers. On the other hand, personal fitting information such as waist size, hat size, and inseam might be the only information that a user wishes to provide to an online retailer for clothing or outdoor gear. Sports interest information may be the only very specific information that a user wishes to make available to a recipient that is associated with sporting-goods merchandising.

Using some type of mechanism such as the granularity level, pre-set template, or explicit entry model just described, user 12 has control of conditions as regards content of information that is provided to a recipient. Another part of this user control relates to specifying limitations on how content 56 can be used.

### Conditions Defining Limitations on Use

Referring back the example shown in FIG. 3, limitations 58 that are provided as part of conditions 52 allow user 12 to define how personal information in content 56 may be used. For example, a user may want to restrict distribution or availability of the information to a particular network session, to a particular recipient or to a broader class of recipients. The user may want to restrict use of personal interest information sent to a recipient for a certain limited period of time. Expiration date information may also be specified if storage of the user information content by the recipient is permissible.

Limitations on use may specify all recipients, a group or groups of recipients, or a particular recipient. At one extreme, a user may be willing to allow unlimited use of the content data provided to a recipient. This would permit the recipient to store, use, and distribute the user-interest information that has been obtained, without a time limit or other constraint. At the other extreme, a user may configure limitations on use very rigidly, so that only a particular recipient or group of recipients may use the content provided, that the information may be used only to configure web page content or presentation for the present session until the user logs off, and that this information must be flushed from memory at the conclusion of the session. Between these two extremes, the user has considerable flexibility for customizing how limitations apply for different groupings of recipients.

Limitations on use also allow a number of other options that can help to address security concerns. A user may require, for example, that some or all of the information of content 56 be provided in some encoded form, making it more difficult for third parties to intercept personal data. The user may also specify what purpose is acceptable for intended use of the data, that is, whether or not the data can be used for masking out or targeting certain information, for providing a web page in a certain format, for automatically moving to a particular home page or type of interaction session, or for customization of what information is provided. The user may permit an online retailer to show products or offers that appear to be of particular interest first, before showing products or offers of more general interest. Alternately, the user may set a limitation that provided content be used only to minimize the need for repetitious user interaction with material presented by the recipient. For example, state tax information can be computed automatically for the user, without the need to enter city and state data. On-line forms that need to be completed for ordering, for inquiries, or for payment can be pre-populated based on the information content.

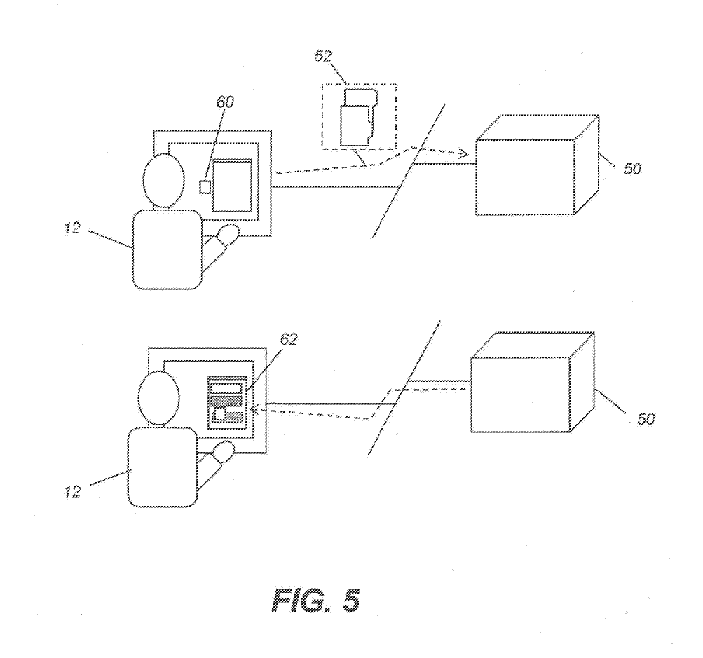

Referring to the exemplary embodiment of FIG. 5, a single-session use for user-interest information is provided. User 12 provides conditions 52 to recipient 50, such as by clicking an icon 60 or using a drag-and-drop operation at the operator interface. Recipient 50 responds by downloading a web page 62 that is customized according to user information that was provided as part of content 52.

### Acceptance of Authorized Use

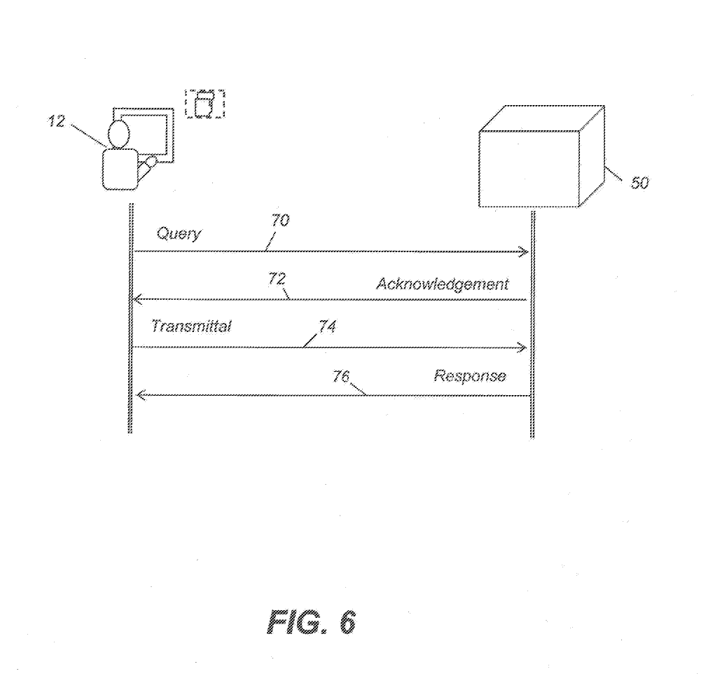

In some embodiments, the user may want to check with an external networked site to determine whether or not the site intends to abide by the user-provided conditions as to limitations. The communication timing diagram of FIG. 6 summarizes the sequence of timing between user 12 and recipient 50 that can be used in such a case.

User 12 begins this sequence by issuing a query 70 to recipient 50. Query 70 indicates that interaction with recipient 50 is desired and that there are user conditions that may be provided along with some amount of user-interest information, but requires positive indication that the limitations presented will be accepted. An acknowledgement 72 from recipient 50 indicates whether or not the user-entered conditions will be honored. A transmittal 74 follows. Where acknowledgement 72 indicated acceptance, transmittal 74 then provides the user provided conditions, as described earlier. A response 76 can then be issued from recipient, with the needed data for providing the desired web page or other appropriate interface presentation. Should acknowledgement 72 be negative for some reason, transmittal 74 and response 76 would change accordingly, either terminating communication between user 12 and recipient 50 or providing some other appropriate response, such as presenting a standard interface to the user. This communication sequence for query 70 forward can execute automatically, not requiring attention or even awareness by user 12.

Using the communication sequence shown in FIG. 6, it is possible to establish interaction of a “trusted” nature between user 12 and recipient 50, providing user 12 with the advantages of a more customized experience in communicating online and providing information to recipient 50 that allows more precise targeting of an advertising or sales message to user 12.

Unlike merchant-provided conditions that prompt the user for responses that dictate user behavior, the user-provided conditions of embodiments of the present disclosure allow configuration to obtain a range of different possible responses from one or more recipients 50. For example, conventional web interface techniques may routinely display a prompt for a yes/no radio button entry on a site such as the following:

“Do you want to receive emails from us?”

In contrast to merchant-provided conditions such as this exemplifies, the user-provided conditions of the present disclosure allow the user to determine how recipient 50 responds to and handles personal interest information about the user in the current online session and what recipient 50 may and may not do with storing, utilizing, or distributing this information in future sessions.

### EXAMPLE

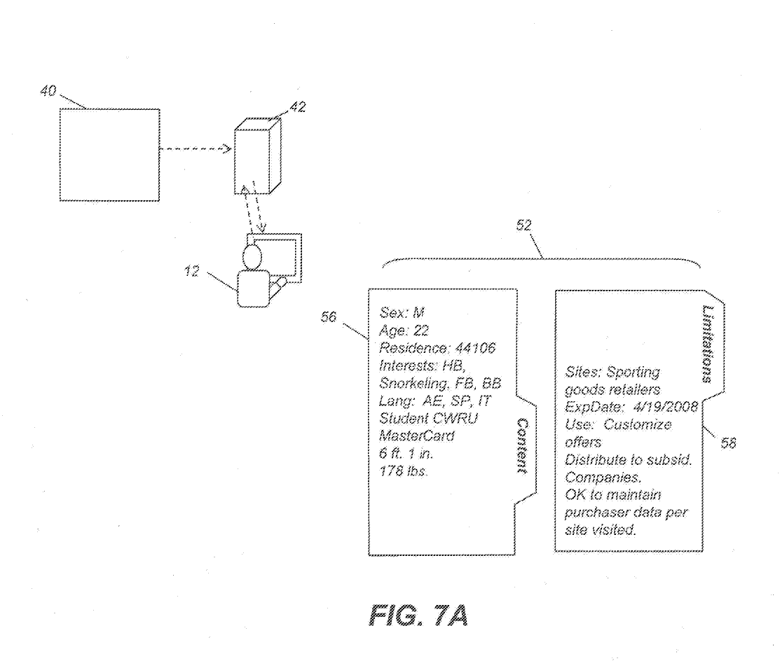

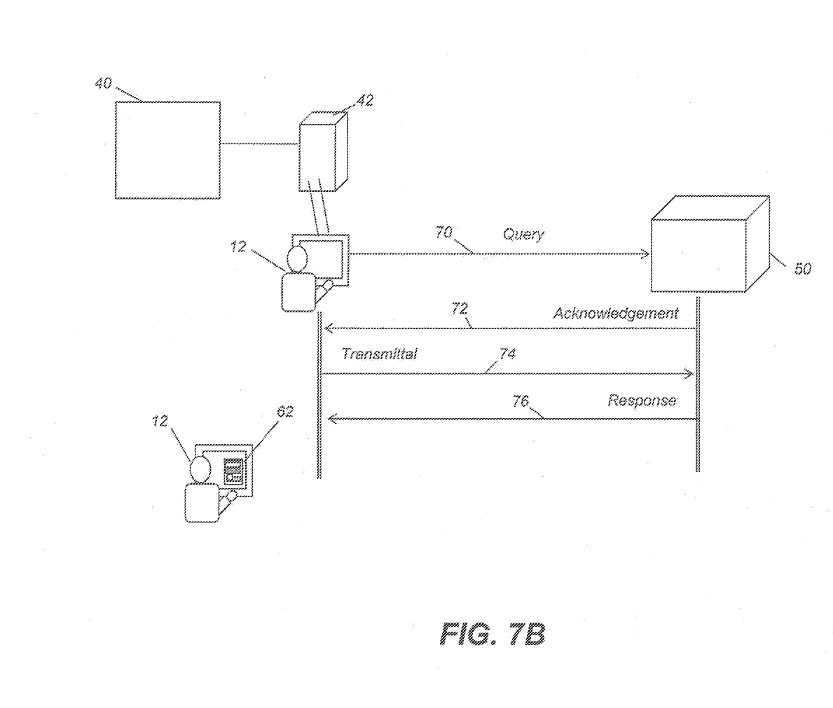

FIGS. 7A and 7B show an illustrative example for embodiments of the present disclosure. User 12 interacts with manager 42 in order to generate conditions 56 and limitations 58. Some information is provided directly by user 12, other information is obtained from preceding online purchases of sporting goods. User 12 allows the given fields shown in content 56. Limitations 58 are to sporting goods retail sites, including subsidiary companies. An expiration date is provided. User 12 has also allowed saving personal purchaser data if a purchase results.

Interaction with recipient 50 begins with query 70 to determine whether or not recipient 50, a sporting goods retailer with an online store, can accept the terms specified in limitations 78 for this user. Positive acknowledgement 72 received, the computer used by user 12 then provides conditions 52 to recipient 50. Response 76 consists of web page 62 that presents portions of the online product catalog for this retailer that correspond to the user interests listed in content 56. In this example, snorkeling, handball, football, and basketball gear are in the foreground of the web page, with other portions of the product catalog accessible, but not immediately displayed. User 12 continues to shop at this site or may link to other sports equipment sites from here, including those of subsidiary companies.

Not shown in this example, but applicable to generating and maintaining content 56 is the use of information from a new purchase made online, as well as information obtained from other web sites that were checked by user 12 during this transaction session. This information can be employed in order to update information in user profile 40 as well as to update content information 56 that is provided to recipient 50. In this way, each transaction can be used to help obtain a more refined set of information about user 12 and user interests overall.

The method of the present disclosure gives a user a measure of control over how much personal information is provided to an online recipient and over how this information can be used. From a user perspective, information that is more likely of interest can be provided when using the web site of a merchant, vendor, or other entity. From a merchandiser's perspective, obtaining some measure of user information allows the customization of an advertising message about a product or offering that is more likely to appeal to a particular user. For both the user and the advertiser, there is at least a measure of agreement on how personal information about user interests is to be used and whether or not it can be retained or distributed for subsequent use in interacting with the user. Thus, advantages for both the user and those with a product or service offering are obtained by embodiments of the present disclosure.

It is to be understood that the exemplary embodiments are merely illustrative of the present disclosure and that many variations of the above-described embodiments can be devised by one skilled in the art without departing from the scope of the disclosure. It is therefore intended that all such variations be included within the scope of the following claims and their equivalents.

The disclosure has been described in detail with particular reference to certain preferred embodiments thereof, but it will be understood that variations and modifications can be effected within the spirit and scope of the disclosure.

What is claimed is:

1. A method comprising:
managing, at a computing device, a user profile comprising information about a user;
receiving, at the computing device, a selection of a condition that indicates a subset of the information about the user from the user profile that is permitted for sharing with a recipient; and
conveying, by the computing device, the subset of information to the recipient in accordance with the selection of the condition that indicates the subset of the information about the user that is permitted for sharing.

2. The method of claim 1, wherein the user profile comprises a history of user online activity, digital records associated with the user, and information inputted by the user.

3. The method of claim 1, wherein the receiving the selection of the condition comprises receiving the selection of the condition from the user.

4. The method of claim 1, wherein the selection of the condition comprises a selection of the subset of the information about the user and a selection of a limitation on sharing of the subset of the information about the user.

5. The method of claim 4, wherein the selection of the subset of the information comprises a selection of an information field from the user profile.

6. The method of claim 4, wherein the limitation on sharing of the subset of the information comprises a limited period of time for which the subset of the information is permitted for sharing.

7. The method of claim 4, wherein the limitation on sharing of the subset of the information comprises specification of one or more recipients for which the subset of the information may only be shared.

8. The method of claim 4, wherein the limitation on sharing of the subset of the information comprises specification of a format in which the subset of the information is to be shared.

9. The method of claim 4, wherein the limitation on sharing of the subset of the information comprises specification of acceptable intended uses by the recipient for the subset of the information.

10. The method of claim 1, wherein the condition comprises a specification of a granularity level that indicates a relative specificity of the subset of information permitted for sharing with the recipient.

11. The method of claim 1, wherein the selection comprises a selection of a template that indicates specific personal information that is permitted for sharing with the recipient.

12. The method of claim 1, wherein the selection comprises a selection of a specific information field from the user profile that is permitted for sharing with the recipient.

13. A non-transitory computer-readable medium having instructions stored thereon that, upon execution by a computing device, cause the computing device to perform operations comprising:
managing a user profile comprising information about a user;
receiving a selection of a condition that indicates a subset of the information about the user from the user profile that is permitted for sharing with a recipient; and
conveying the subset of information to the recipient in accordance with the selection of the condition that indicates the subset of the information about the user that is permitted for sharing.

14. The non-transitory computer-readable medium of claim 13, wherein the selection of the condition comprises a selection of the subset of the information about the user and a selection of a limitation on sharing of the subset of the information.

15. The non-transitory computer-readable medium of claim 14, wherein the limitation on sharing of the subset of the information comprises a limited period of time for which the subset of the information is permitted for sharing.

16. The non-transitory computer-readable medium of claim 14, wherein the limitation on sharing of the subset of the information comprises a specification of one or more recipients for which the subset of the information is permitted for sharing.

17. The non-transitory computer-readable medium of claim 14, wherein the limitation on sharing of the subset of the information comprises a specification of acceptable intended uses by the recipient for the subset of the information.

18. The non-transitory computer-readable medium of claim 13, wherein the condition comprises a specification of a granularity level that indicates a relative specificity of the subset of information permitted for sharing with the recipient.

19. The non-transitory computer-readable medium of claim 13, wherein the selection comprises a selection of a template that indicates specific personal information that is permitted for sharing with the recipient.

20. The non-transitory computer-readable medium of claim 13, wherein the selection comprises a selection of a specific information field from the user profile that is permitted for sharing with the recipient.

21. A system comprising:
a database configured to store a user profile comprising information about a user; and
a management system coupled to the database, wherein the management system is configured to:
receive a selection of a condition that indicates a subset of the information about the user from the user profile that is permitted for sharing with a recipient; and
convey the subset of information to the recipient in accordance with the selection of the condition that indicates the subset of the information about the user that is permitted for sharing.

22. The system of claim 21, wherein the management system is configured to derive information about the user from the user profile based on a probably assessment of the information about the user in the user profile.

23. The system of claim 21, wherein the selection of the condition comprises a selection of the subset of the information about the user and a selection of a limitation on sharing of the subset of the information.

24. The system of claim 21, wherein the limitation on sharing of the subset of the information comprises a limited period of time for which the subset of the information is permitted for sharing.

25. The system of claim 23, wherein the limitation on sharing of the subset of the information comprises a specification of one or more recipients for which the subset of the information is permitted for sharing.

26. The system of claim 23, wherein the limitation on sharing of the subset of the information comprises a specification of acceptable intended uses by the recipient for the subset of the information.

27. The system of claim 21, wherein the condition comprises a specification of a granularity level that indicates a relative specificity of the subset of information permitted for sharing with the recipient.

28. The system of claim 21, wherein the selection comprises a selection of a template that indicates specific personal information that is permitted for sharing with the recipient.
